(19) United States
(12) Patent Application Publication
(10) Pub. No.: US 2006/0233522 A1
(43) Pub. Date: Oct. 19, 2006

(54) Video processing apparatus

(76) Inventors: Kazushige Hiroi, Machida (JP); Yoshifumi Fujikawa, Yokohama (JP); Norikazu Sasaki, Ebina (JP); Riri Ueda, Ebina (JP); Akio Hayashi, Tokyo (JP); Yukio Fujii, Yokohama (JP); Atsuo Kawaguchi, Sagamihara (JP)

Correspondence Address: MCDERMOTT WILL & EMERY LLP, 600 13TH STREET, N.W., WASHINGTON, DC, 20005-3096, US

(21) Appl. No.: 11/369,184

(22) Filed: Mar. 7, 2006

(30) Foreign Application Priority Data
Apr. 19, 2005 (JP) 2005-120484

(51) Int. Cl. H04N 7/00

(52) U.S. Cl. 386/95

(57) ABSTRACT

A video processing technique which enables users to effectively watch highlight scenes while listening to audio part thereof in a short period of time is disclosed. Upon input of video data, highlight scene data describing therein a highlight scene(s) in the video data is input or generated. Then, based this highlight scene data, determine a default playback parameter. Control is provided to reproduce the highlight scene(s) of the video data in a way such that when inputting a parameter for determination of a playback scene(s), this input playback parameter is used while giving thereto higher priority than the default playback parameter.

### INCORPORATION BY REFERENCE

The present application claims priority from Japanese application JP2005-120484 filed on Apr. 19, 2005, the content of which is hereby incorporated by reference into this application.

### BACKGROUND OF THE INVENTION

The present invention relates to an apparatus for processing moving pictures to reproduce video data.

Recent advances in digital television broadcast technologies bring rapid growth in multi-channel broadcasting of video or video data and also result in wider frequency bands of networks. This in turn enabled acquisition or audio-visual enjoyment of a great amount of video data. In addition, owing to improvements in video compression/decompression techniques and price reduction of hardware/software for achieving them along with an increase in capacity of storage media and a decrease in costs thereof, it has become possible to readily perform the saving of an increased amount of video data, which leads to a likewise increase in watchable video data. However, busy persons usually have no or less time to watch every part of the video data, resulting in overflow of watchable video data in some circumstances. Consequently, it becomes important to provide a technique for allowing a user to selectively watch and listen to only his or her preferred or “important” scenes in the video data to thereby enable establishment of a scheme for understanding the contents of interest within a short length of time period and a system for permitting the user to quickly search specific part of the video data that s/he truly wants to watch.

In light of the technical background, an exemplary approach to enabling on-screen visualization of only important or highlight scenes in video data is disclosed in JP-A-2003-153139. Another selective scene display technique is found in D. DeMenthon, V. Kobla, and D. Doermann, “Video Summarization by Curve Simplification”, ACM Multimedia 98, Bristol, England, (pp. 211-218, 1998).

In particular, the DeMenthon et al. article discloses therein a technique for generating characteristic portions from video data and for extracting and ranking highlight scenes based on the features to thereby reproduce highlight scenes only at a user-assigned scene-skip rate.

### SUMMARY OF THE INVENTION

Although several techniques for allowing the user to grasp the contents of video data in a short time period are proposed, it seems that the proposed techniques fail to provide user interfaces preferable to end users. For example, in JP-A-2003-153139, it is possible to watch every scene that appears to be important. Unfortunately, it suffers from a problem as to the lack of an ability to partially or entirely watch important video data parts within a time period convenient to the user, because it is impossible to assign a playback time and playback percentage. Regarding the technique taught from DeMenthon document, it is difficult or almost impossible for the user to figure out exactly how to determine an appropriate scene skip ratio in order to achieve effective viewing of highlight scenes only, although an ability is provided to play back only important scenes at a ratio which is manually assigned by the user.

This invention was made to avoid the problems in the prior art, and it is an object of the invention to provide a video processing apparatus capable of permitting users to effectively grasp the contents of video data.

To attain the foregoing object, a video processing apparatus in accordance with one aspect of the invention is arranged to include a video data input unit for inputting video data, a highlight scene data input/generation unit for inputting or generating highlight scene data with a description of an important scene or scenes in the video data, a default playback parameter determination unit for determining a default playback parameter based on the highlight scene data entered or generated by the highlight scene data input/generation unit, a playback parameter input unit for input of a parameter for determination of a playback scene(s), and a control device which provides control in such a way as to preferentially use, when the playback parameter is input by the playback parameter input unit, the playback parameter as input by the playback parameter input unit rather than the playback parameter determined by the default playback parameter determination unit to reproduce the playback scene(s) of the video data.

According to the invention, it becomes possible to effectively catch the contents of the video data, thereby improving the usability of end users.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing an exemplary hardware configuration employable when functional blocks of a video processing apparatus embodying this invention is realized on a software program basis.

FIG. 2 illustrates, in function block diagram form, an exemplary configuration of the video processing apparatus in accordance with an embodiment 1 of the invention.

FIGS. 3A and 3B are diagrams each showing in table form a structure of feature data to be handled by the embodiment of the invention.

FIG. 4 shows in table form a structure of highlight scene data to be dealt by the embodiment 1 of the invention.

FIGS. 5A to 5C are diagrams showing exemplary display screens for setup of a playback time and/or play ratio in accordance with the embodiment of the invention.

FIGS. 6A to 6C are diagrams each showing, in table form, a structure of playback scene data as handled in the embodiment 1 of the invention.

FIGS. 7A to 7C are diagrams for explanation of a playback scene determination method in accordance with the embodiment 1 of the invention.

FIG. 8 depicts an exemplary playback operation panel of the video processing apparatus embodying the invention.

FIG. 9 is a flowchart showing a playback procedure and an overall operation of the video processing apparatus embodying the invention.

FIG. 10 is a diagram for explanation of a scene to be reproduced by the playback processing of the video processing apparatus embodying the invention.

FIG. 11 is a function block diagram of a video processing apparatus in accordance with an embodiment 2 of the invention.

FIG. 12 shows, in table form, an exemplary structure of ranking data to be handled by the embodiment 2 of the invention.

FIG. 13 shows an exemplary structure of highlight scene data being handled by the embodiment 2 of the invention.

FIGS. 14A to 14C are diagrams each showing an exemplary structure of playback scene data to be dealt in the embodiment 2 of the invention.

FIGS. 15A to 15C are diagrams for explanation of a playback scene determination method in accordance with the embodiment 2 of the invention.

FIG. 16 is a function block diagram of a video processing apparatus in accordance with another embodiment of the invention.

### DESCRIPTION OF THE INVENTION

### Embodiment 1

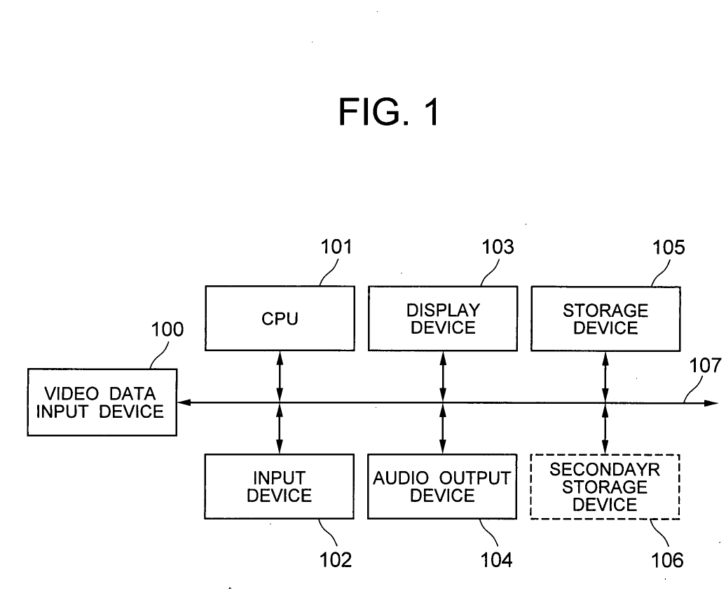

FIG. 1 shows an exemplary hardware configuration of a video processing apparatus incorporating the principles of this invention.

As shown in FIG. 1, the video processing apparatus in accordance with the embodiment 1 is generally made up of a video data input device 100, a central processing unit (CPU) 101, an input device 102, a display device 103, an audio output device 104, a storage device 105, and a secondary storage device 106. Respective devices are connected together by a bus 107 to thereby permit mutual data transfer/reception therebetween. Note here that the secondary storage device 106 is an auxiliary component of the storage device 105 and thus is eliminatable in cases where the storage device 105 has extended functionality covering the function of it.

The video data input device 100 inputs video or video data. This input device 100 may typically be comprised of a device which reads the video data being stored in the memory device 105 or secondary storage device 106 in a way to be later described or, alternatively, a television (TV) tuner in the case of receiving broadcast TV programs. When inputting video data via network links, the video data input device 100 is configurable from a network card, such as a local area network (LAN) card or the like.

The CPU 101 is mainly arranged by a microprocessor, which is a control unit that executes software programs as stored in the storage device 105 or secondary storage device 106.

The input device 102 is realizable, for example, by a remote control, keyboard, or pointing device called the “mouse,” for enabling a user to enter more than one playback scene determination parameter, which will be discussed later.

The display device 103 is configurable, for example, by a display adapter and a liquid crystal display (LCD) panel or projector or else. When performing entry of one or some playback scene images and/or a playback scene determination parameter(s) via a graphical user interface (GUI), it displays this GUI. One example of this GUI will be described in detail later.

The audio output device 104 is arranged, for example, to include a speaker(s) for outputting sounds and voices of the scenes being reproduced.

The storage device 105 is implemented, for example, by a random access memory (RAM) or read-only memory (ROM) or equivalents thereto, for storing therein a software program(s) to be executed by the CPU 101 and the data to be processed by this video processing apparatus or, alternatively, video data to be reproduced and/or ranking data relating thereto.

The secondary storage device 106 is designable to include, for example, a hard disk drive (HDD) or a digital versatile disk (DVD) drive or a compact disc (CD) drive or a nonvolatile memory, such as “Flash” memory or the like. The secondary storage 106 stores therein a software program(s) to be executed by the CPU 101 and the data being processed by this video processing apparatus or, alternatively, the video data to be played back and/or the ranking data.

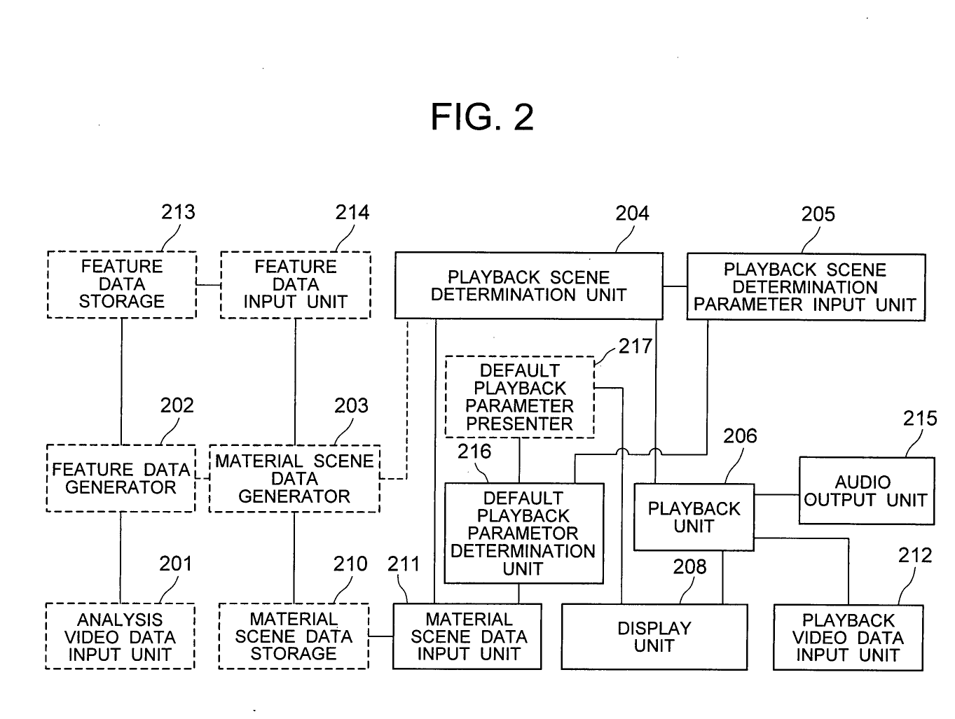

See FIG. 2, which depicts, in functional block diagram form, an arrangement of the video processing apparatus in accordance with this embodiment 1. In the following description, it is assumed that every function block is a software program which is executable under control of the CPU 101, although the functions of these blocks may be realized by using hardware modules when the need arises.

As shown in FIG. 2, the video processing apparatus of this embodiment 1 is generally made up of an analysis video data input unit 201, feature data generator 202, feature data retaining unit 213, feature data input unit 214, highlight scene data generator 203, highlight scene data storage 210, highlight scene data input unit 211, default playback parameter determination unit 216, default playback parameter presenter 217, playback video data input unit 212, playback scene determination unit 204, playback scene determination parameter input unit 205, playback unit 206, display unit 208, and audio output unit 215.

It should be noted that in cases where the video processing apparatus generates no highlight scene data and alternatively uses the highlight scene data which has already been prepared by another apparatus, some of the illustrative components are eliminatable, i.e., the analysis video data input unit 201, feature data generator 202, feature data storage 213, feature data input unit 214, highlight scene data generator 203 and highlight scene data storage 210.

Additionally in case the video processing apparatus is not expected to create the feature data and alternatively uses the feature data that has already been prepared by another apparatus, the analysis video data input unit 201 and feature data generator 202 plus feature data storage 213 are not always necessary. In case it is unnecessary to present the default playback parameter to the user, the default playback parameter presenter 217 is eliminatable.

The analysis video data input unit 201 generates and analyzes the features of video images in order to determine one or several highlight scenes of video data while inputting from the video data input device 100 for production of the feature data and highlight scene data respectively. Note that the analysis video data input unit 201 is rendered operative by the CPU 101 when instructed by the user to prepare such feature data and highlight scene data or upon start-up of playback or when a scheduler (not depicted) finds video data with the feature data and highlight scene data being not yet created.

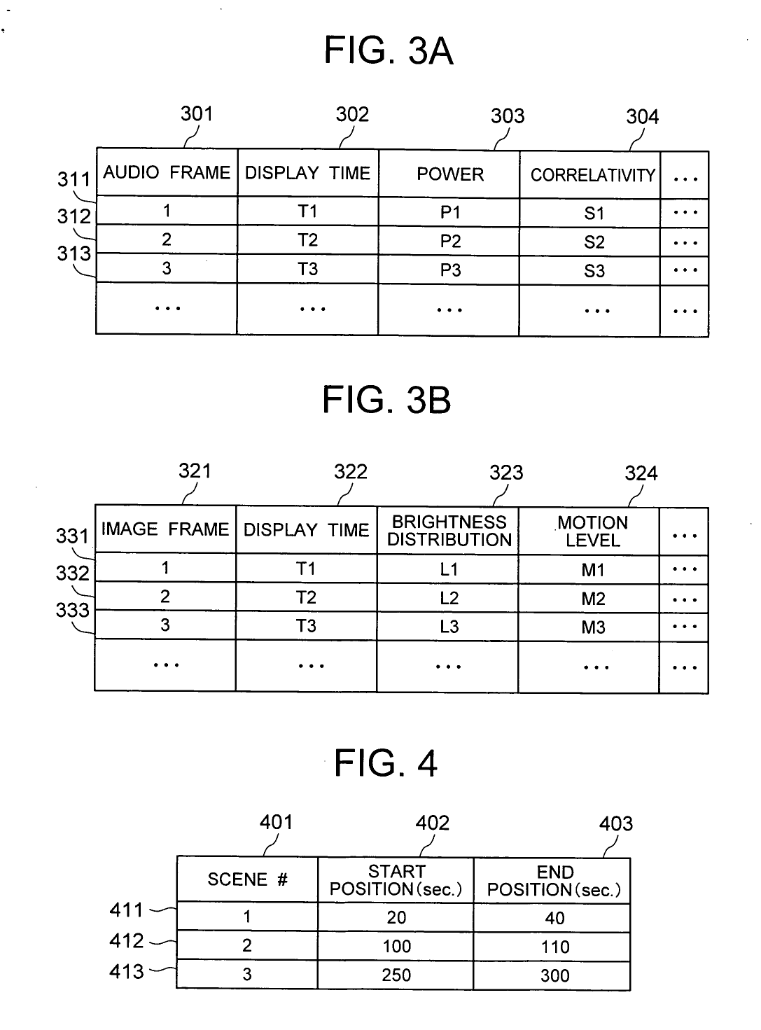

The feature data generator unit 202 generates features of the video data as input at the analysis video data input unit 201. This is realizable by generation of some factors—e.g., audio power, correlativity, image brightness distribution, and magnitude of motion—in regard to a respective frame of audio data and image data in the video data as shown for example in FIGS. 3A and 3B.

Exemplary feature data of audio part is shown in FIG. 3A, while feature data of image part is shown in FIG. 3B in table form. In FIG. 3A, reference numeral 301 designates the number of an audio frame, and numerals 311 to 313 denote audio frames respectively. In addition, 302 indicates a time point at which an audio frame is output; 303 denotes the voice/sound power in such audio frame; 304 is the correlativity of the audio frame with respect to another audio frame, which may be realized by defining self-correlativity against another audio frame. In FIG. 3B, numeral 321 designates an image frame number; 331 to 333 denote respective image frames. Additionally, 322 indicates an instant whereat the image frame of interest is output; 323 is a brightness distribution in such image frame; 324, the movement of the image frame from another image frame.

The brightness distribution 323 is obtainable, for example, by a process having the steps of dividing the image frame of interest into several regions and then providing a histogram of average luminance values in respective regions. The magnitude of movement is realizable for example by a process including dividing such image frame into several regions, generating in each region a motion vector with respect to an immediately preceding frame, and calculating an inner product of respective motion vectors generated. The feature data generator 202 is operated or executed by CPU 101 whenever video data is input upon execution of the analysis video data input unit 201.

The feature data storage 213 retains therein the feature data as generated at the feature data generator 202. This is realizable for example by letting the feature data created by feature data generator 202 be stored in either the storage device 105 or the secondary storage device 106. Additionally the feature data storage 213 may be designed so that upon activation of feature data generator 202, it is executed by CPU 101 whenever the feature data is generated or when a one frame of feature data is generated.

The feature data input unit 214 permits entry of the feature data being presently retained in the feature data storage 213 or the feature data that has already been prepared by another apparatus. This is realizable, for example, by readout of the feature data being stored in the storage device 105 or the secondary storage device 106. This feature data input unit 214 may be executed by CPU 101 upon execution of the highlight scene data generator 203 in a way as will be described later.

The highlight scene data generator 203 is equivalent in functionality to the highlight scene data input/generation means as claimed, which uses the feature data as input by the feature data input unit 214 to determine one or more important or highlight scenes, thereby generating highlight scene data such as shown in FIG. 4. In FIG. 4, numeral 401 denotes a highlight scene number, and 411 to 413 indicate highlight scenes, respectively. Numeral 402 shows the starting position of such highlight scene whereas 403 is the end position thereof. The start and end positions may be replaced with a start time and end time respectively. This embodiment will be set forth under an assumption that the start time and end time are described in the highlight scene data for purposes of convenience in discussion. This highlight scene data generator 203 performs highlight scene determination in a way which follows. For example, suppose that the video data involves the contents of a music TV program, detect music part through evaluation of its audio power and/or correlativity.

Even when the video data is of the contents other than music TV programs, similar results are obtainable by a process which includes finding the appearance of a typical pattern based on the brightness distribution and/or the movement of a video image, recognizing it as a highlight scene, and detecting this highlight scene.

The highlight scene data generator 203 is executed by CPU 101 when instructed by the user to create highlight scene data, upon startup of reproduction, or when a scheduler (not shown) finds video data with the highlight scene data being not yet prepared.

The highlight scene data storage 210 retains the highlight scene data as generated at the highlight scene data generator 203. This is implemented for example by storing the highlight scene data generated at the highlight scene data generator 203 in either one of the storage device 105 and the secondary storage device 106. Note however that in case the highlight scene data generated at highlight scene data generator 203 is arranged to be directly read into the default parameter determination unit 216 and playback scene determination unit unit 204 in a way as will be described later, the highlight scene data storage 210 is not always required. In case the highlight scene data storage 210 is designed to exist, this storage 210 may be arranged to be executed by CPU 101 when highlight scene data is generated upon execution of the highlight scene data generator 203.

The highlight scene data input unit 211 is equivalent in function to the highlight scene data input/generation means as claimed and is operable to input the highlight scene data being held in the highlight scene data storage 210 or highlight scene data that has already been created by another device. This is realizable for example by readout of the highlight scene data being stored in the storage device 105 or secondary storage device 106. Note here that this highlight scene data input unit 211 is eliminatable in case the highlight scene data as generated at the highlight scene data generator 203 is read directly into the default parameter determination unit 216 and the playback scene determination unit 204. In case system designs permit presence of the highlight scene data input unit 211, this input unit may be arranged to be executed by CPU 101 when the playback scene determination unit 204 or default parameter determination unit 216 is executed in a way as will be discussed later.

The default parameter determination unit 216 corresponds to the default playback parameter determination means as claimed and functions to determine a default playback parameter(s) based on the above-stated highlight scene data. This is realizable by calculation of a total playback time period of the whole video data after having obtained a total sum of respective highlight scene time periods in the highlight scene data. Alternatively, a technique is usable for calculating a ratio of the total playback time of highlight scenes to a playback time of entire video data. More specifically, in case the highlight scene data is the data shown in FIG. 4 and the time taken to reproduce the entire video data is 500 seconds, determine the default playback parameter in such a way that the playback time is 80 seconds (=(40−20)+(110−100)+(300−250)) or the playback ratio is 16% (=80÷500×100). The default parameter determination unit 216 may be arranged to be activated by CPU 101 upon execution of the playback scene decision parameter input unit 205 in a way described later.

The default playback parameter presenter unit 217 is equivalent to the default playback parameter presentation means claimed and is operable to present the user with the playback parameter determined by the default playback parameter determination unit 216. This is realizable for example by causing the playback time or playback ratio calculated by the default playback parameter determination unit 216 to be displayed on the display device 103 via the display unit 208. While various practical examples are conceivable, one example thereof is to display as the default value an input value at the playback scene decision parameter input unit 205 in a way to be later discussed. Exemplary display screens will be described in detail in conjunction with an explanation of the playback scene determination parameter input unit 205. Although the default playback parameter presenter 217 is deemed unnecessary in case no default playback parameters are presented to the user, it is desirable for the user that a time length or playback ratio to be assigned when wanting to effectively watch important scenes is used by default and is presented. In case the default playback parameter presenter 217 is designed to exist, this default playback parameter presenter 217 may be arranged to be executed by CPU 101 after completion of the processing of the above-stated default parameter determination unit 216 upon execution of the playback scene decision parameter input unit 205 in a way to be later discussed.

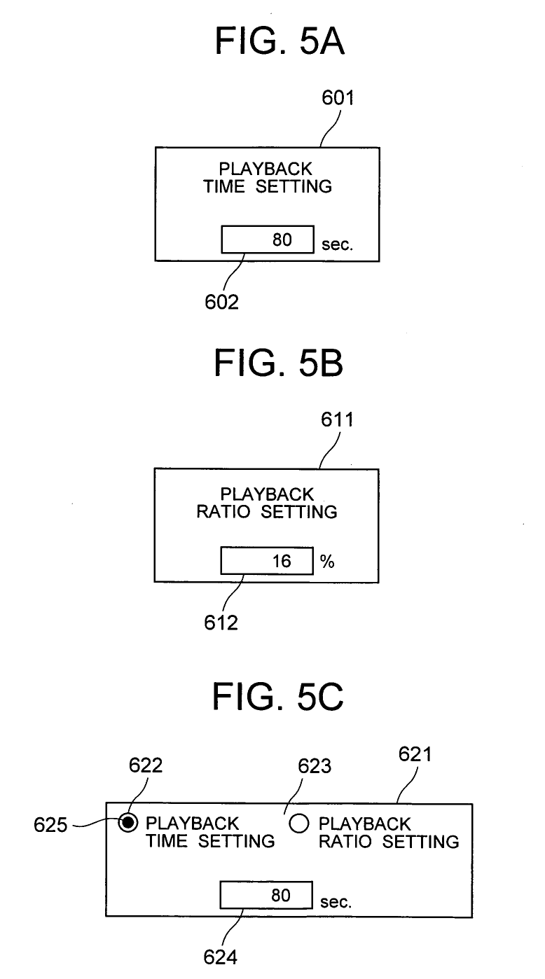

The playback scene determination parameter input unit 205 is equivalent to a playback scene determination parameter input means and operates to input via the input unit 102 more than one parameter for determination of a playback scene(s). More specifically, for example, it displays window-like display screens shown in FIGS. 5A to 5C on a remote control or on the display device 103 via the display unit 208.

In FIGS. 5A to 5C, FIG. 5A illustrates an example of a display screen in the case of setting up a playback time, and FIG. 5B depicts a display screen for setup of a playback ratio. FIG. 5C shows a display screen that allows the user to selectively designate either a playback time or a playback ratio.

In FIG. 5A, numeral 601 denotes a playback time setup window, and 602 indicates a playback time appointing area. In FIG. 5B, numeral 611 is a playback ratio setup window, and 612 is a playback ratio setup area. In FIG. 5C, numeral 621 denotes a playback-time/ratio setup window; 622 shows a playback time setting button; 623 is a playback ratio setup button; 624, a playback-time/ratio setup area; 625, an indicator.

In FIG. 5A, the user is capable of setting by using the input device 102 a desired playback time length into the playback time setup area 602. At this time, it may be designed to display, when the playback time setup window 601 is displayed, the playback time that is determined at the default parameter determination unit 216 and presented by the default playback parameter presenter 217. With such arrangement, it becomes possible for the user to readily grasp the playback time to be appointed when wanting to watch highlight scenes effectively.

In FIG. 5B, the user is allowed to use the input device 102 to enter a desired playback ratio in the playback ratio setup area 612. At this time, it may be arranged to display, when the playback ratio setup window 611 appears, the playback ratio which was determined at the default parameter determination unit 216 and presented by the default playback parameter presenter 217. This makes it possible for the user to readily grasp the playback ratio to be appointed when wanting to watch highlight scenes successfully.

In FIG. 5C, the user can decide by using the input device 102 which one of the playback time or playback ratio is assigned. More precisely, when the user pushes down the playback time appoint button 622, the video processing apparatus goes into a playback time assigning mode, thereby enabling the user to set up a desired playback time in the playback-time/ratio setup area 624. In this case, an indicator may preferably be displayed near the playback time setup button as shown in FIG. 5C.

Alternatively, in case the user pushed down the playback ratio setup button 623, the video processing apparatus goes into a playback ratio appoint mode, enabling the user to set up a desired playback ratio in the play-time/ratio setup area 624.

In this case, an indicator may be displayed near the playback-time/ratio appoint button although not specifically depicted. At this time, an arrangement is employable for displaying, when the playback-time/ratio appoint window 621 appears, the playback time or ratio which is determined by the default parameter determination unit 216 and presented by the default playback parameter presenter 217 in the mode that was set previously.

Thus it becomes possible for the user to readily figure out the playback time or ratio to be appointed when wanting to watch important scenes effectively. Additionally, when either the playback time setup button 622 or the playback ratio setup button 623 is operated by the user resulting in a change in mode, recalculation may be executed to alter the parameter value in a mode before such change to the updated parameter value, which is then displayed in the playback-time/ratio setup window 621.

FIG. 5C exemplifies that the user assigns his or her preferred playback time length. Also note that the playback scene decision parameter input unit 205 is rendered operative by CPU 101 at the time the playback of highlight scenes is executed at the playback unit 206 in a way as will be described later.

Also note that the examples of FIGS. 5A to 5C are modifiable in such a way as to display a window which permits entry of a parameter by the user in a state that the default playback parameter is presently displayed. If this is the case, the user can input his or her desired parameter value while simultaneously referring to the default value, so the usability is superior.

Furthermore, even after having once input a desired parameter value through the user's manipulation of the default value, it will possibly happen that the user thinks the default value is better than the input value due to the fact that the user changes his or her mind or due to an operation error or else. Supposing the occurrence of such scene, it is very likely that the usability further increases if a mechanism is available for going back to the default value by a simplified operation. Examples of the simple operation are to push down a specified button and to click with a certain region (including an icon indicative of the “Default Value”).

In this case, a control signal for instruction of output of the default value is input to the CPU 101 by the above-stated operation. In responding thereto, CPU 101 executes the processing for visualization of a display screen on the remote control or at the display device 103 by way of the display unit 208. Whereby, it is expected to further improve the usability.

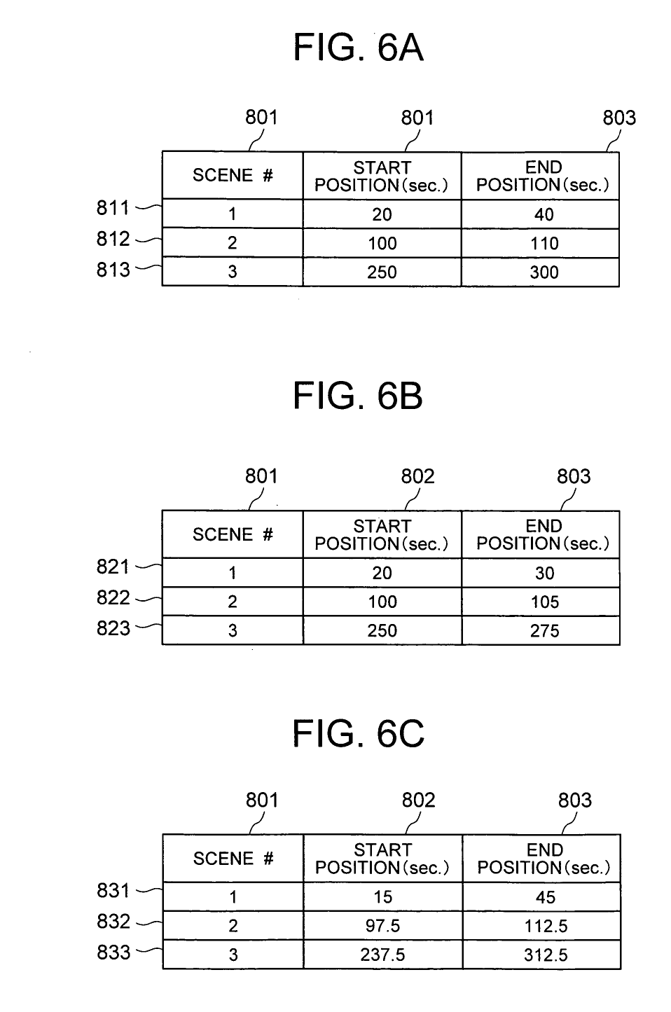

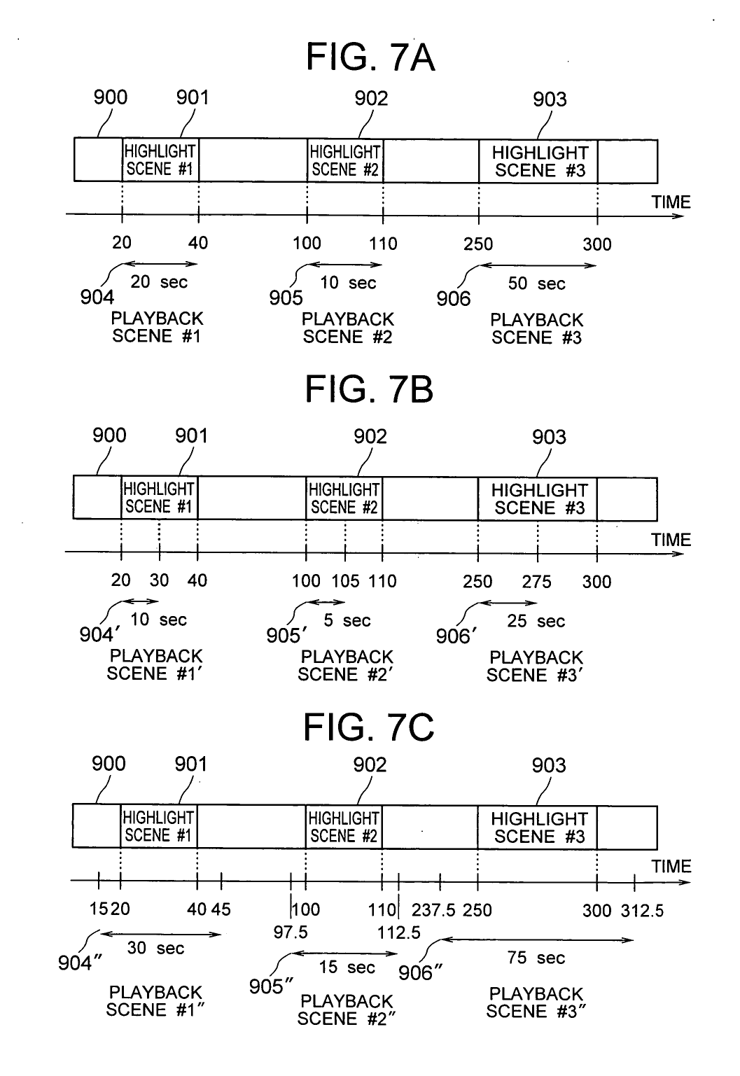

The playback scene determination unit 204 corresponds to the playback scene determination means claimed, and operates to determine playback scenes based on the parameter as input at the playback scene decision parameter input unit 205 and the highlight scene data that was generated by the highlight scene data generator 203 or input by the highlight scene data input unit 211. More specifically, for example, in case the highlight scene data is the data shown in FIG. 4 and either “80 seconds” is input as the playback time or “16%” is input as the playback ratio in the playback scene decision parameter input unit 205, every highlight scene which is described in the highlight scene data is reproducible, so determine as the playback scenes those scenes indicated in FIGS. 6A and 7A.

FIGS. 6A to 6C and FIGS. 7A to 7C show the playback scenes determined by the playback scene determination unit 204, wherein FIGS. 6A to 6C depict playback scene data structures whereas FIGS. 7A to 7C indicate playback scene determination methodology. In particular, FIGS. 6A and 7A show a case where the value of a playback parameter that was input by the playback scene decision parameter input unit 205 is the same as the value of a playback parameter determined by the default parameter determination unit 216 with respect to the highlight scene(s) shown in FIG. 4, that is, when the playback parameter determined at the default parameter determination unit 216 is input in the playback scene decision parameter input unit 205 or alternatively when a parameter value as presented at the default playback parameter presenter 217 is input in the playback scene decision parameter input unit 205.

In FIG. 6A, numeral 801 denotes the number of a playback scene, and 811 to 813 indicate respective playback scenes. Additionally, 802 designates the start position of such playback scene; 803 is the end position thereof. Note here that the start and end positions may be replaced by a start time and an end time respectively. In this embodiment, an explanation will be given while assuming that the start and end positions of playback scene are the start and end time points respectively, for purposes of convenience in discussion herein.

In FIG. 7A, numeral 900 denotes video or video data, 901 to 903 indicate highlight scenes #1 to #3 respectively, and 904 to 906 are respective playback scenes #1 to #3. As can be seen from FIGS. 6A and 7A, the highlight scenes are identically the same as the playback scenes because the playback parameter as input by the playback scene decision parameter input unit 205 is the same as the playback parameter determined by the default parameter determination unit 216.

In another exemplary case where the highlight scene data is the one shown in FIG. 4 and either “40 seconds” is input as the playback time or “8%” is input as the playback ratio in the playback scene decision parameter input unit 205, every highlight scene described in the highlight scene data is reproducible, so determine as the playback scene each highlight scene-shortened scene. Practically, for example, determine as each playback scene the first-half part of each highlight scene as shown in FIGS. 6B and 7B.

It is not always required to set it as the first-half part; for example, either the second-half part or a center-containing half portion is alternatively employable. Still alternatively, any half part is usable which involves an audio power-maximal point or a specific image portion on the image or a half part with this point as its front end. A further alternative example for use as the playback scene is an ensemble of portions of a prespecified length as extracted from respective scenes; in the above-noted example, what is required is to shorten the entire highlight scenes by 40 seconds in total, so a portion of 40÷3≈13.4 seconds is cut from each highlight scene for use as the playback scene. In this case, the remaining portions which are out of such cutting and used as playback scenes may also be arranged to contain the first- or second-half part of highlight scene or a central part thereof or, alternatively, contain an audio power-maximized point or specific image point on the image; still alternatively, this point may be designed so that its front end becomes a playback scene.

Note that FIGS. 6B and 7B show a specific case where the value of a playback parameter as input by the playback scene decision parameter input unit 205 is with the playback time of 40 seconds or the playback ratio of 8% which is one-half of the value of a playback parameter determined at the default parameter determination unit 216 (the default playback time of 80 seconds and the default playback ratio of 16%) in a way relating in particular to the highlight scenes shown in FIG. 4 in the event that the first-half part of each highlight scene is defined as the playback scene.

In FIG. 6B, 801 is the number of a playback scene, and 821 to 823 indicate respective playback scenes. Additionally, 802 denotes the start position of such playback scene; 803 is the end position thereof. Note that the start and end positions may be set as a start time and an end time, respectively. In this embodiment, an explanation will be given under an assumption that the start and end positions of playback scene are the start and end time points respectively for purposes of convenience in discussion herein.

In FIG. 7B, 900 is video data, 901 to 903 are respective highlight scenes #1 to #3, and 904 (to 906) denote respective playback scenes #1 (to #3). As apparent from FIGS. 6B and 7B, each playback scene is part of its corresponding highlight scene with a total playback time of respective playback scenes being set at 40 seconds and with a playback ratio set to 8% because the value of a playback parameter as input at the playback scene decision parameter input unit 205 has the playback time of 40 seconds and the playback ratio of 8%. Further, for example, in case the highlight scene data is that shown in FIG. 5 and either “120 seconds” is input as the playback time or “24%” is input as the playback ratio in the playback scene decision parameter input unit 205, the intended reproduction is executable since it is longer than all the highlight scenes being described in the highlight scene data. Thus, determine as the playback scene each scene with its highlight scene being lengthened.

Practically, for example, determine as each playback scene a scene which contains each highlight scene with its head and tail portions extended as shown in FIGS. 6C and 7C. Note however that it is not always necessary to extend both the head and tail portions; for example, only one of the head and tail may be extended. Although in FIGS. 6C and 7C the head and tail portions of a scene are elongated together at the same rate in accordance with the length ratio of each highlight scene as one example, the invention should not be limited thereto. For example, each scene may be extended uniformly or alternatively a wide variety of different settings may be employable—for example, let the head/tail-extension ratio be set at 2:1.

Note that FIGS. 6C and 7C show a specific case where the value of a playback parameter as input by the playback scene decision parameter input unit 205 is with the playback time of 20 seconds or the playback ratio of 24% which is 1.5 times greater than the playback parameter value determined at the default parameter determination unit 216 (the default playback time of 80 seconds and the default playback ratio of 16%) in a way specifically relating to the highlight scenes shown in FIG. 4 in the event of extension at a ratio proportional to the length of each highlight scene and extension with the head/tail ratio of 1:1, resulting in the playback scene setup. In FIG. 6C, 801 is the number of a playback scene; 831 to 833 denote playback scenes, respectively.

In addition, 802 indicates the start position of such playback scene whereas 803 denotes the end position thereof. It is noted that the start and end positions may be set to a start time and an end time, respectively: in this embodiment, an explanation will be given while assuming that the start and end positions of a playback scene are the start and end time points, respectively, for convenience in discussion herein.

In FIG. 7C, 900 indicates video data, 901 to 903 denote respective highlight scenes #1 to #3, and 904 (to 906) are playback scenes #1 (to #3) respectively. It can be seen from FIGS. 6C and 7C that each playback scene contains each highlight scene with a total playback time of respective playback scenes being set at 120 seconds and with the playback ratio set to 24% because the value of a playback parameter as input at the playback scene decision parameter input unit 205 has the playback time of 120 seconds and playback ratio of 24%.

Incidentally, the playback scene determination unit 204 is rendered operative by the CPU 101 after input of a playback parameter at the playback scene decision parameter input unit 205 or when it is assigned that the default value is acceptable.

The playback motion-picture data input unit 212 corresponds to the motion data input means as claimed and is operable to input from the video data input device 100 the video data to be reproduced. This playback video data input unit 212 gets started upon acquisition of the to-be-reproduced video data by the playback unit 206 in a way as will be discussed later and is then executed by CPU 101.

The display unit 208 is equivalent in function to the display means claimed and operates to visually display the playback images produced by the playback unit 206. This display unit 208 displays the playback images on the screen of display device 103 on a per-frame basis. In this case, the display unit 208 is activated by playback unit 206 whenever a one frame of playback image is generated by playback unit 206, and executed by CPU 101. Optionally this may be designed to display any one of the pop-up windows shown in FIGS. 5A to 5C. In this case, it may be arranged so that a frame of this GUI is produced upon startup of the playback scene decision parameter input unit 205, and CPU 101 renders display unit 208 operative whenever the GUI frame is modified or updated such as in the event of an input from the user, resulting in this frame being displayed.

The audio output unit 215 is also equivalent to the claimed display means and functions to display at the audio output device 104 the playback sounds and voice as produced at the playback unit 206. This audio output unit 215 is realizable in a way that the playback sound/voice produced by playback unit 206 is output to the audio output device 104 in units of frames. In this case the audio output unit 215 is activated and executed by CPU 101, once at a time, whenever a one frame of playback sound/voice is created by playback unit 206.

The playback unit 206 corresponds to the playback means and inputs the video data of a playback scene or scenes determined by the playback scene determination unit 204 via the playback motion-picture data input unit 212 and then generates playback images, which are displayed at the display device 103 by way of display unit 208. In addition, it produces playback audio components, which are output to the audio output unit 215. Details of the processing contents in playback unit 206 will be set forth later together with an entire operation. The playback unit 206 is executed by CPU 101 in case normal playback or highlight scene reproduction is instructed by the user.

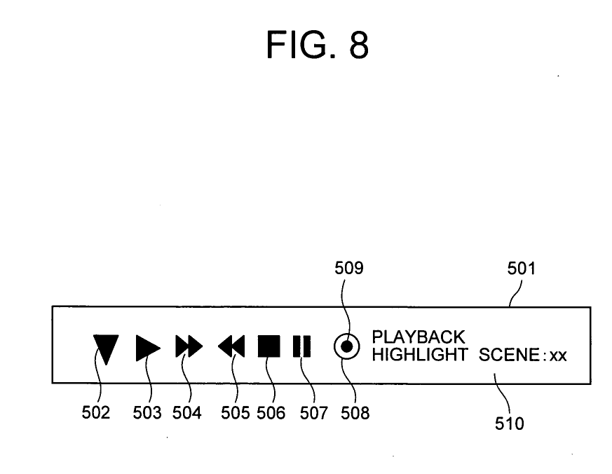

Next, one example of the playback operation panel of the video processing apparatus will be described while referring to FIG. 8.

In FIG. 8, numeral 501 denotes an operation panel; 502 indicates a video data selector button; 503 designates a playback button; 504 shows a fast forward button; 505 is a rewind button; 506, a stop button; 507, a pause button; 508, highlight scene playback assign button; 509, highlight scene play indicator. The user of this video processing apparatus is allowed to choose playback video data by using the input device 102 to manually operate the video data selector button 502. This is achievable by employing an arrangement which follows: when the video data select button 502 is operated, CPU 101 generates a list of reproducible video data items, divides the data into multiple image frames, renders the display unit 208 operative for display on the display device 103, and permits the user to choose his or her desired playback video data via the input device 102. This processing has already been implemented in commercially available hard disk recorders or the like, so its detailed description is eliminated herein. Similarly, the user of this video processing apparatus can make instructions of video data playback start, fast forward start, rewind start, stop and pause of the video data as selected by operation of the video data selector button 502, through operations of the play button 503, fast-forward button 504, rewind button 505, stop button 506 and pause button 507, respectively. These processes are also implemented in standard hard disk recorders or else, so a detailed discussion thereof is omitted here.

As previously stated, the illustrative video processing apparatus comes with the highlight scene playback instruction button 508. The user is allowed via operation of this button 508 to give instructions as to highlight scene playback startup or highlight scene playback completion with respect to the video data chosen by operation of the video data selector button 502. This is arranged for example in such a way as to perform startup of highlight scene playback upon single pressing of the highlight scene playback instruction button 508 and complete the highlight scene playback and then return to normal reproduction when the same button is pushed once again. An operation at this time will be described later in conjunction with the entire operation of the video processing apparatus along with detailed processing contents of the playback unit 206.

The highlight scene playback indicator 509 may be designed to illuminate during reproduction of highlight scenes.

Respective buttons on the playback operation panel 501 may be arranged by physical buttons on the remote control or may alternatively be overlaid on the display device 103 via the display unit 208 after the image framing was done by CPU 101. If this is the case, the playback time or playback ratio as input by the playback scene decision parameter input unit 205 may be displayed in vicinity of the highlight scene playback instruction button 508 as indicated by 510 in FIG. 8, wherein “xx” denotes the playback time or playback ratio which was input by the playback scene decision parameter input unit 205.

In case the remote control has its own display panel thereon, the playback time or playback ratio as input by the playback scene decision parameter input unit 205 may be displayed on this display panel. In such case, the remote control may be designed for example to acquire, when the highlight scene playback instruction button 508 is pressed resulting in entry of an instruction to start playback of highlight scenes, the playback time or playback ratio as input by the playback scene decision parameter input unit 205 in association with the video processing apparatus by access using infrared rays.

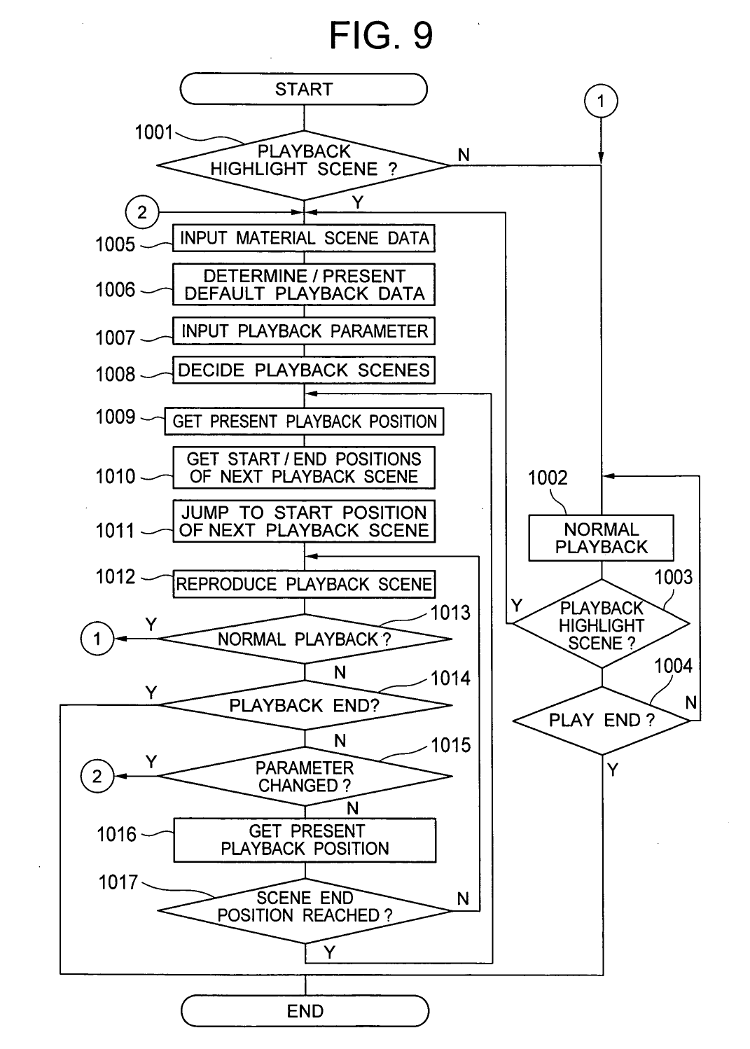

Next, an entire operation of the video processing apparatus along with the playback processing contents at the playback unit 206 will be discussed with reference to a flowchart of FIG. 9.

As shown in FIG. 9, when video or video data is assigned and upon receipt of the instruction to start playback or highlight scene reproduction, the video processing apparatus performs an operation which follows.

Firstly the playback unit 206 determines whether the highlight scene playback is instructed (at step 1001).

If the decision at step 1001 affirms that such highlight scene playback is not instructed yet, then perform normal reproduction (at step 1002). An explanation of the normal playback is eliminated as it has widely been carried out in the art. In the video processing apparatus embodying the invention, a decision as to whether the highlight scene playback is instructed or not is made by judging at regular intervals whether the highlight scene playback instruction button 508 is pressed (at step 1003). In case a present playback session is ended without receipt of any highlight scene playback instruction (at step 1004), terminate the playback. In ordinary reproduction, when completing display of the whole video data or when playback ending is instructed from the user, determine as the end of the playback; otherwise, continue execution of the ordinary playback operation.

When it is determined that highlight scene playback is assigned as a result of the decision at the step 1001, the highlight scene playback is carried out in a way which follows. First, receive highlight scene data as input by the highlight scene data input unit 211 (at step 1005). If the highlight scene data is absent, then activate relevant units—e.g., the analysis video data input unit 201, feature data generator 202, feature data storage 213, feature data input unit 214, highlight scene data generator 203, and highlight scene data storage 210—for production of highlight scene data or, alternatively, perform ordinary playback while displaying a message saying that no highlight scene data is found. An alternative arrangement is that when the highlight scene data is absent, the highlight scene playback instruction button 508 is invalidated; still alternatively, in case the highlight scene playback instruction button 508 is designed to be displayed on the display screen, disable the displaying of this button 508.

In case the highlight scene data can be input successfully, the playback unit 206 then causes the default parameter determination unit 216 to calculate the default playback parameter. When the default playback parameter presenter 217 exists, display the default playback parameter calculated (at step 1006).

Subsequently, the playback scene decision parameter input unit 205 inputs the playback parameter (at step 1007), followed by determination of playback scenes by the playback scene determination unit 204 (step 1008).

Then, acquire a present playback position in the video data (at step 1009). Based on this present playback position, acquire the start position and end position of another playback scene next thereto (step 1010). This is realizable by acquisition of the start and end positions of a playback scene out of the playback scenes determined by the playback scene determination unit 204, which is behind the present playback position and is closest thereto.

Next, the playback unit 206 jumps (at step 1011) to the start position of the next playback scene as acquired at the step 1010, and then performs reproduction of this playback scene (step 1012). This is achieved by displaying a video image in the playback scene on the display device 103 via the display unit 208 and also outputting playback sounds and voices in the playback scene to the audio output device 104 by way of the audio output unit 206.

Additionally, determine at regular intervals whether the highlight scene playback instruction button 508 is pushed down or alternatively whether the playback button 503 is depressed during reproduction of this playback scene, thereby deciding whether the ordinary playback is designated (at step 1013). If such ordinary playback is assigned then go to the ordinary playback of steps 1002 to 1004.

During reproduction of the playback scene, an attempt is made at regular intervals to judge whether the playback is completed (at step 1014). If the reproduction is over then terminate the reproduction of the video data. Note here that in the process of reproducing the highlight scenes, when having completed every playback scene determined by the playback scene determination unit 204 or when instructed by the user to terminate the playback operation, it is determined to end the playback; otherwise, continue reproducing playback scenes. Furthermore, during the playback scene reproduction, an attempt is made at fixed intervals to judge whether the playback parameter is modified (at step 1015). If the playback parameter is changed then return to step 1005.

If the playback parameter is kept unchanged, then subsequently acquire a present playback position (at step 1016) and determine whether it reaches the end position of the playback scene (step 1017). This is determinable by comparing the end position of the playback scene acquired at the step 1010 to the present playback position obtained at the step 1016.

In case a result of the decision at step 1017 indicates that the present playback position does not yet reach the end position of the playback scene, repeat the processes of steps 1012 to 1017 to thereby continue the playback scene reproduction. Alternatively, if the decision result at step 1017 reveals that it has reached the end position of the playback scene, then repeat the steps 1009 to 1017 to thereby sequentially reproduce those playback scenes determined by the playback scene determination unit 204. Upon completion of all the playback scenes determined by playback scene determination unit 204, recognize it at step 1014, followed by termination of the reproduction.

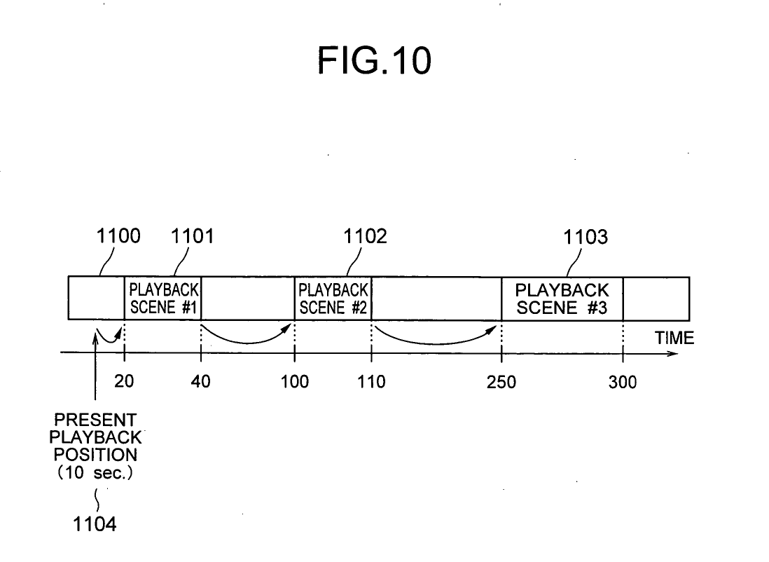

With this procedure, as shown in FIG. 10, it becomes possible to reproduce only those playback scenes determined by the playback scene determination unit 204 while jumping to respective playback scenes. Additionally, FIG. 10 is a diagram for explanation of certain playback scenes to be reproduced at the playback unit 206 as built in the video processing apparatus embodying the invention. In FIG. 10, numeral 1100 denotes an entirety of video data; 1104 is a present playback position; and, 1101 to 1103 indicate playback scenes determined at playback scene determination unit 204.

In FIG. 10, a present playback position is the position of 10 seconds, and the playback scenes determined by the playback scene determination unit 204 exemplify the playback scenes of FIGS. 6A and 7A for purposes of convenience. In this video processing apparatus, it becomes possible by the above-stated processing of the playback unit 206 to sequentially reproduce only the chosen playback scenes while jumping to a playback scene #1, and to playback scene #2 and then to playback scene #3.

Although in this embodiment the explanation was given as to one specific case where a present playback position is prior to the start position of initial playback scene, practical applicability is also available in cases where such present playback position is behind the start positions of several playback scenes. In this case, a technique may be used for inhibiting reproduction of any playback scene before the present position or for excluding it from the objects to be processed stated supra. Whereby, there are dynamically enabled the default playback parameter determination and presentation by the default parameter determination unit 216 and default playback parameter presenter 217, the playback parameter entry by the playback scene decision parameter input unit 205, and the playback scene decision by the playback scene determination unit 204.

### Embodiment 2

In an embodiment 2, a video processing apparatus is provided, which performs ranking (grading) of scenes in the video or video data and then determines based thereon appropriate highlight scenes and playback scenes.

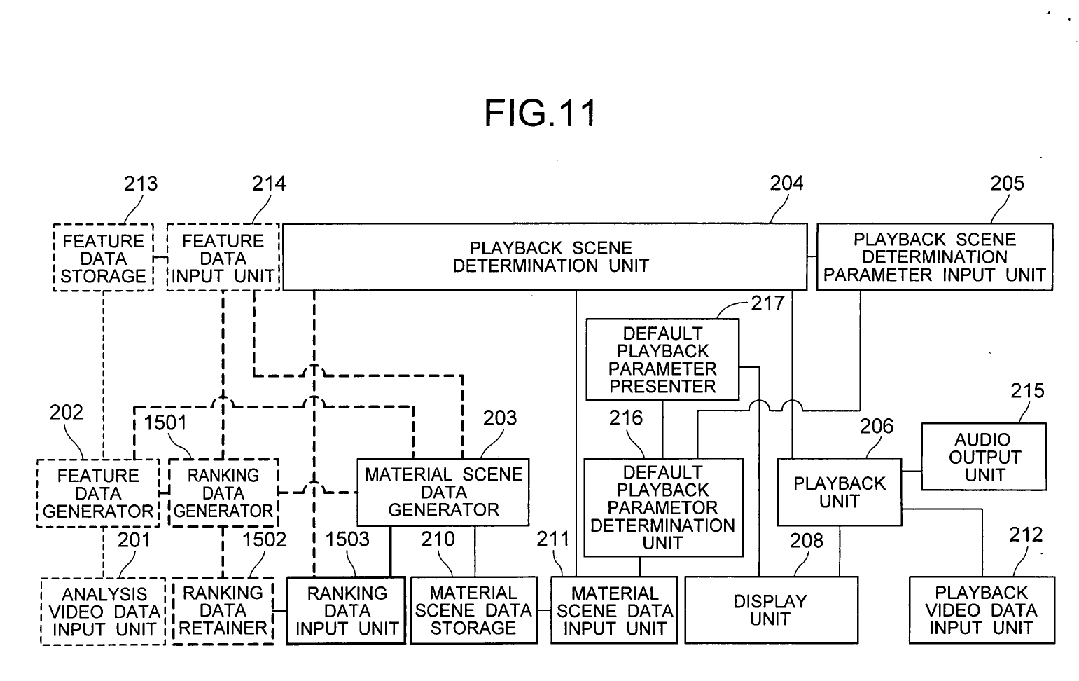

FIG. 11 is a functional block diagram of the video processing apparatus in accordance with the embodiment 2.

As shown in FIG. 11, the video processing apparatus of this embodiment is made up of a ranking data generation unit 1501 and a ranking data retaining unit 1502 plus a ranking data input unit 1503 in addition to the function blocks of the video processing apparatus of the embodiment 1 stated supra. While these function blocks may be partly or entirely realized in the form of hardware in addition to the hardware configuration shown in FIG. 1, such are alternatively realizable by software programs executable by the CPU 101. In the description below, it is assumed that all of these function blocks are software programs to be executed by CPU 101, as one example. In cases where the ranking data is not generated by the video processing apparatus such as in the case of using ranking data as has been prepared by another apparatus or device, it is not always necessary to equip the analysis video data input unit 201, feature data generator 202, feature data storage 213, feature data input unit 214, ranking data generator 1501, and ranking data retainer 1502. Optionally in case the video processing apparatus is not expected to generate feature data such as when using characteristic data that has already been prepared by another apparatus, the analysis video data input unit 201 and feature data generator 202 plus feature data storage 213 are not required.

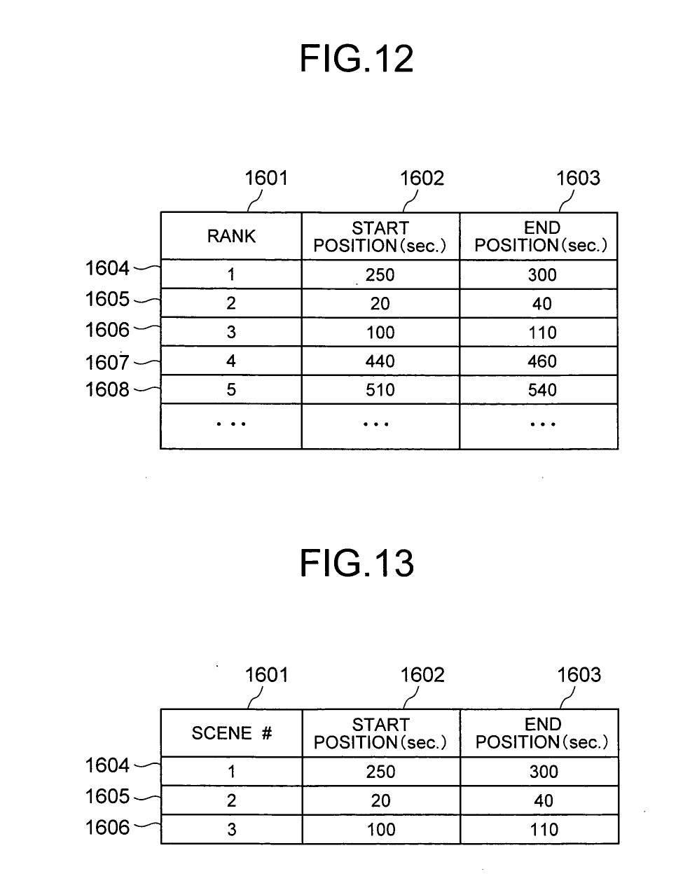

The ranking data generator 1501 is equivalent in functionality to the ranking data input/generation means as claimed and is responsive to receipt of the feature data as input at the feature data input unit 214, for performing ranking of scenes in video data to thereby generate ranking data such as shown in FIG. 12. In FIG. 12, reference numeral 1601 denotes a scene number, and 1604 to 1608 indicate scenes in the video data, respectively 1602 is the start position of a scene; 1603, an end position of the scene. Note here that the start and end positions may be a start time and an end time respectively. In this embodiment, an explanation will be given while assuming that the playback scene start and end positions are the start and end time points respectively, for purposes of convenience only. The scene ranging in the ranking data generator 1501 is achievable by known methods, such as that taught from the DeMenthon et al. article as cited previously. An alternative approach to realizing this is to detect, in case the video data is of the contents of a music TV program, music parts by audio correlation ratio evaluation methods or else and then apply ranking thereto in the order that a scene with high audio power is higher in rank than another with low audio power.

Alternatively, even when the video data has its contents other than music TV programs, similar results are also obtainable in such a way that when a typical scene appears, heighten the rank of such scene based on either the brightness distribution or the movement of video image, for example. Obviously, the intended scene ranking is attainable by using these methods in combination.

The ranking data generator 1501 is rendered operative by CPU 101 when preparation of ranking data is instructed by the user or when reproduction gets started or when a scheduler (not shown) detects certain video data with its ranking data being not yet prepared.

The ranking data retainer 1502 holds therein the ranking data generated at the ranking data generator 1501. This is realizable by letting the ranking data generator 1501's output ranking data be stored in the storage device 105 or the secondary storage device 106.

This ranking data retainer 1502 is not always necessary in case an arrangement is used for permitting the ranking data generated by the ranking data generator 1501 to be directly read into the highlight scene data generator 203. In case the ranking data retainer 1502 is arranged to exist, this retainer 1502 may be arranged to be executed by CPU 101 whenever the ranking data is created during operation of the ranking data generator 1501.

The ranking data input unit 1503 corresponds to the ranking data input/generation means as claimed and operates to input either the ranking data retained in the ranking data retainer 1502 or the ranking data as created in advance by another device or apparatus. This may be realized for example by readout of the ranking data being stored in the storage device 105 or secondary storage device 106. In case an arrangement is used which permits the ranking data generator 1501's output ranking data to be directly read into the highlight scene data generator 203, this ranking data input unit 1503 is eliminatable. In case the ranking data input unit 1503 is designed to exist, this input unit 1503 is arranged to be executed by CPU 101 when the highlight scene data generator 203 is activated.

In this embodiment 2, the processing of the analysis video data input unit 201, feature data input unit 214, highlight scene data generator 203 and playback scene determination unit 204 will be modified in a way which follows.

The analysis video data input unit 201 generates and analyzes video image features in order to perform the ranking of scenes in video data and determine a highlight scene(s) while inputting from the video data input device 100 in order to generate the feature data and the ranking data plus the highlight scene data. This analysis video data input unit 201 is rendered operative by the CPU 101 when instructed by the user to prepare the feature data, ranking data or highlight scene data, upon startup of reproduction, or when a scheduler (not shown) finds certain video data without preparation of the feature data, ranking data or highlight scene data.

The feature data input unit 214 permits entry of the feature data as held in the feature data storage 213 or the feature data as has been already generated by another apparatus or device. This is realizable, for example, by readout of the feature data being stored in the storage device 105 or the secondary storage device 106. Additionally the feature data input unit 214 may be executed by CPU 101 upon activation of the ranking data generator 1501 or the highlight scene data generator 203.

The highlight scene data generator 203 uses the feature data as input at the feature data input unit 214 and the ranking data generated at the ranking data generator 1501 to determine highlight scenes and then generates highlight scene data such as shown in FIG. 13. In FIG. 13, numeral 1601 indicates the number of a highlight scene, 1604 to 1606 denote highlight scenes respectively, and 1602 shows the start position of such highlight scene whereas 1603 is the end position thereof. The start and end positions may be a start time and an end time respectively. In this embodiment an explanation below assumes that the start and end positions of playback scene are the start and end times respectively, for purposes of convenience.

The determination of highlight scenes in this highlight scene data generator 203 is achievable for example by using audio portions in the ranking data in case the video data has the contents of a music TV program. Even when its contents are other than the music program, similar results are also obtainable by extraction of a scene with appearance of a typical pattern based on the luminance distribution and/or movement of video image in the ranking data by way of example. Alternative examples include, but not limited to, a scene with its audio pattern being greater than or equal to a specified level in the ranking data, a scene with its luminance more than or equal to a specified level in the ranking data, a specific scene having a prespecified luminance distribution in the ranking data, and any given upper-level scene in the ranking data.

In FIG. 13, one specific example is shown which determined as the highlight scenes those scenes with ranks “1” to “3” from the ranking data shown in FIG. 12 to thereby generate highlight scene data. The highlight scene data generator 203 is executed by CPU 101 when instructed by the user to prepare highlight scene data or when reproduction gets started or when a scheduler (not shown) finds certain video data with preparation of no highlight scene data. In the example of FIG. 13, if the video data is 500 seconds in time length then the default playback time that is determined by the default parameter determination unit 216 is 80 seconds (=(40−20)+(110−100)+(300−250)) whereas the default playback ratio becomes 16% (=80÷500×100).

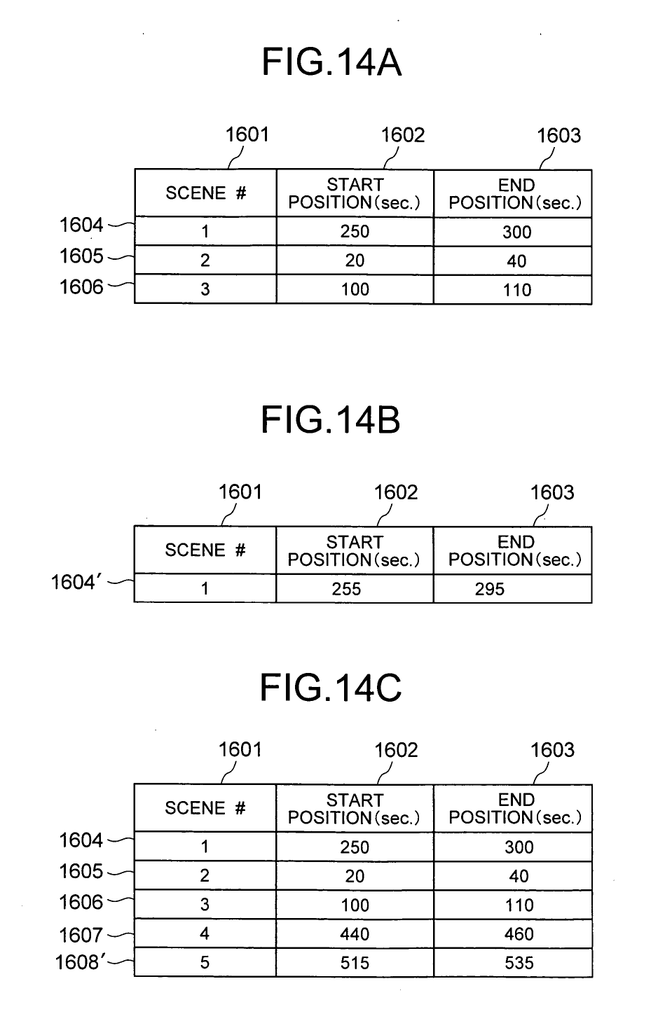

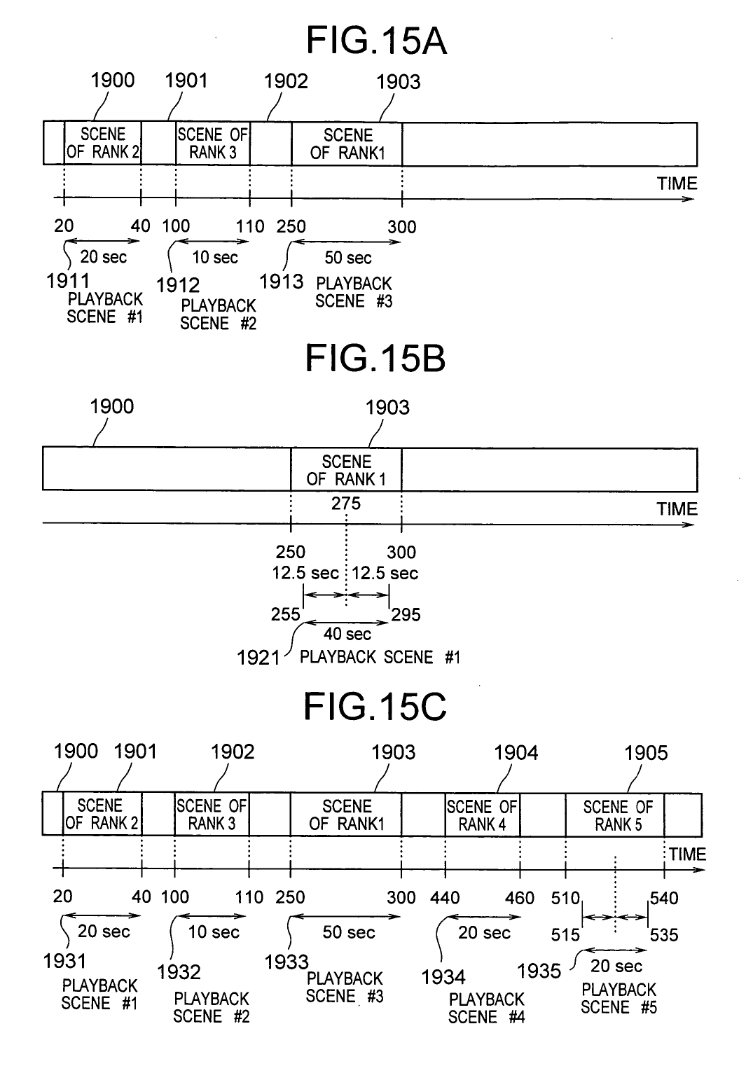

The playback scene determination unit 204 determines one or some playback scenes based on the parameter as input by the playback scene decision parameter input unit 205 and the ranking data generated by the ranking data generator 1501 or entered at the ranking data input unit 1503 plus the highlight scene data generated by the highlight scene data generator 203. Practically, in an exemplary case where the ranking data for video data of 500 seconds is the data shown in FIG. 12 and the highlight scene data is the data shown in FIG. 13, when either the playback time of 80 seconds or the playback ratio of 16% is input to the playback scene decision parameter input unit 205, it is possible to reproduce all the highlight scenes described in the highlight scene data, so determine the scenes shown in FIGS. 14A and 15A as the playback scenes.

FIGS. 14A to 14C and FIGS. 15A to 15C show those playback scenes that are determined by the playback scene determination unit 204, wherein FIGS. 14A to 14C indicate playback scene data structures whereas FIGS. 15A to 15C show play scene determination methods. In particular, FIGS. 14A and 15A show, as for the highlight scenes of FIG. 13, a certain case where the playback parameter as input by the playback scene decision parameter input unit 205 is the same in value as the playback parameter determined at the default parameter determination unit 216, that is, when the playback parameter value determined by the default parameter determination unit 216 is input to the playback scene decision parameter input unit 205 or when the parameter value that was presented at the default playback parameter presenter 217 is input to the playback scene decision parameter input unit 205.

In FIG. 14A, numeral 1601 is a playback scene number, and 1604 to 1606 indicate respective playback scenes 1602 denotes the start positions of such play scene, whereas 1603 is the end position thereof. Optionally the start and end positions may be replaced by a start time and an end time respectively—in this embodiment, an explanation below assumes that the start and end positions of playback scene are the start and end time points respectively, for purposes of convenience in discussion.

In FIG. 15A, numeral 1900 denotes video data, 1901 to 1903 indicate scenes of ranks “2,” “3” and “1” respectively, which are also the highlight scenes #1, #2 and #3. Additionally 1911 to 1913 indicate playback scenes #1 to #3, respectively.

In FIGS. 14A and 15A, it can be seen that the highlight scenes simply become the playback scenes since the playback parameter as input by the playback scene decision parameter input unit 205 is identically the same in value as the playback parameter decided at the default parameter determination unit 216.

Alternatively, in case the highlight scene data of video data with its time length of 500 seconds is the data shown in FIG. 13 while the ranking data is the data shown in FIG. 12 as an example, when either the playback time of 40 seconds or the playback ratio of 8% is input to the playback scene decision parameter input unit 205, it is impossible to play every highlight scene described in the highlight scene data, so determine some of them as the playback scenes in the order that a scene of higher rank in the ranking data is selected preferentially.

Practically, for example, in the above-stated example, high-rank scenes with a total time length of 40 seconds are selected as the playback scenes in the way shown in FIGS. 14B and 15B. Note that in this example, the scene of the highest rank is 50 seconds in time length, so cut the rank-1 scene into a portion of 40 seconds. At this time, as shown in FIGS. 14B and 15B, such cut portion may be any part other than a central part of the scene of 40 seconds or, alternatively, part other than a top or “head” portion of the scene with its time length of 40 seconds. In the case of cutting the front and rear portions of such scene, a ratio of the front cut to the rear cut may be determined appropriately on a case-by-case basis. Still alternatively, a portion which includes the center of the scene while excluding the 40-second part may be cut away; obviously, the last or “tail” portion of the scene may be cut away while leaving the 40-second part. A further example is that a portion which contains an audio power-maximized point or a specific picture point on the image or with this point as its top edge may be cut away while leaving the 40-second part. To make a long story short, in cases where an accumulated scene playback time fails to fall within the playback time or the playback ratio as input at the playback scene decision parameter input unit 205, adjust the playback time by means of the length of a scene with the lowest rank. It is also acceptable to inhibit reproduction of the lowest-rank scene.

In FIGS. 14B and 15B, there is shown concerning the highlight scenes shown in FIG. 13 a specific case where when the value of a playback parameter as input by the playback scene decision parameter input unit 205 is with the playback time of 40 seconds or the playback ratio of 8% which is less than or equal to the playback parameter value determined at the default parameter determination unit 216 (the default playback time of 80 seconds and the default playback ratio of 16%), let a scene of the highest rank in the ranking data shown in FIG. 12 be the playback scene while at the same time cutting this scene to have a time length of 40 seconds as this scene is the lowest in rank. In FIG. 14B, numeral 1601 is the number of a playback scene whereas 1604′ denotes a playback scene.

In addition, 1602 indicates the start position of such playback scene while 1603 is the end position of it. Optionally the start and end positions may be replaced by a start time and an end time respectively. In this embodiment, an explanation will be given under an assumption that the start and end positions of playback scene are the start and end time points respectively, for purposes of convenience in discussion. Additionally in FIG. 15B, 1900 denotes video data, 1903 is a scene of rank 1, which is the highlight scene #1. 1921 indicates a playback scene #1.

As apparent from FIGS. 14B and 15B, the value of playback parameter as input by the playback scene decision parameter input unit 205 has the playback time of 40 second and the playback ratio of 8% so that the playback scene is part of the highlight scene with a total playback scene being such that the playback time is 40 seconds and playback ratio is 8%. Further, in case the highlight scene data of the video data of 500 seconds is the data shown in FIG. 13 with the ranking data being the data shown in FIG. 12 for example, when a playback time of 120 seconds or a playback ratio of 24% is input at the playback scene decision parameter input unit 205, it is possible to perform reproduction for a longer time than all the highlight scenes being described in the highlight scene data, so add to the playback scene those selected scenes which are relatively high in rank in the ranking data.

Practically, for example, in the above-stated example, select as the playback scenes some scenes which are higher in rank and a total time length of which is 120 seconds as shown in FIGS. 14C and 15C. More specifically, as shown in FIGS. 14C and 15C, determine as the playback scenes respective scenes of the rank 1 to rank 5. If a total sum of these scenes is in excess of the playback time or the playback ratio as input at the playback scene decision parameter input unit 205, then adjust the playback time by means of the length of a scene having the lowest rank. In other words, in the above-stated example, cut the rank-5 scene into a portion of 20 seconds, thereby letting a total playback time be equal to 120 seconds or making its playback ratio equal to 8%. At this time, the scene cutting may be modified to cut its front and rear portions to ensure that resultant playback scene becomes the center; alternatively, cut its forefront first. In the case of cutting the front and rear portions, a ratio of the front cut to the rear cut may be determined appropriately. A portion which includes the center of the scene may be cut away; alternatively, the scene's last portion may be cut away. Still alternatively, the cutting may be done so that the playback scene contains an audio power-maximized point or a specific picture point on the image or in a way that this point is at its top edge, thereby providing the intended playback scene. It is also permissible to prevent reproduction of the lowest-rank scene.

In FIGS. 14C and 15C, there is shown a specific case where when the value of a playback parameter as input by the playback scene decision parameter input unit 205 is with the playback time of 120 seconds or the playback ratio of 24% which is greater than or equal to the playback parameter value determined by the default parameter determination unit 216 (the default playback time of 80 seconds and the default playback ratio of 16%) in a way relating to the highlight scenes shown in FIGS. 14A to 14C, let respective scenes of ranks 1 to 5 be the playback scenes while cutting a scene of rank 5 to have a shortened time length of 20 seconds, thereby adjusting so that a total time length of entire scene assembly is 120 seconds or less. In FIG. 14C, numeral 1601 indicates a playback scene number, and 1604 to 1607 denote scenes of ranks 1 to 4, which are playback scenes.

A scene 1608 is also the playback scene, and is a part of the rank-5 scene. Numeral 1602 denotes the start position of such playback scene, and 1603 is the end position thereof. The start and end positions may be replaced by a start time and an end time respectively. In this embodiment, an explanation will be given while assuming that the start and end positions of playback scene are the start and end time points respectively, for purposes of convenience only. Additionally in FIG. 15C, 1900 designates video data, 1901 to 1905 are respective portions of the scenes of ranks 1 to 5, and 1931 to 1935 indicate playback scenes #1 to #5, respectively.

It can be seen from FIGS. 14C and 15C that, as the value of the playback parameter as input to the playback scene decision parameter input unit 205 is such that its playback time is 120 seconds and playback ratio is 2.4%, each playback scene contains therein a highlight scene with a total time length of respective playback scenes being set at 120 seconds and also with the playback ratio being equal to 24% as a result of addition of cantles of the rank-4 scene and rank-5 scene as playback scenes.

This embodiment 2 is further arranged to activate, when the highlight scene data is absent at the step 1005 in FIG. 9, respective units involved—i.e., the analysis video data input unit 201, feature data generator 202, feature data storage 213, feature data input unit 214, ranking data generator 1501, ranking data retainer 1502, ranking data input unit 1503, highlight scene data generator 203 and highlight scene data storage 210—to thereby generate highlight scene data or, alternatively, perform ordinary reproduction while simultaneously displaying a message saying that no highlight scene data is found. Another approach is to use an arrangement for invalidating the highlight scene playback instruction button 508 when no highlight scene data is found or alternatively prevent visual displaying of the highlight scene playback instruction button 508 in cases where this button 508 is designed to be displayed on the display screen. With such an arrangement, it becomes possible to reproduce the highlight scenes in the order that a scene of higher rank is played prior to the others.

Although in the embodiments 1 and 2 the highlight scene data generator 203 and playback scene determination unit 204 are designed to perform fixed processing irrespective of the category of video data, the processing may be modified to switch between the methods shown in the embodiments 1 and 2 in compliance with the video data category.

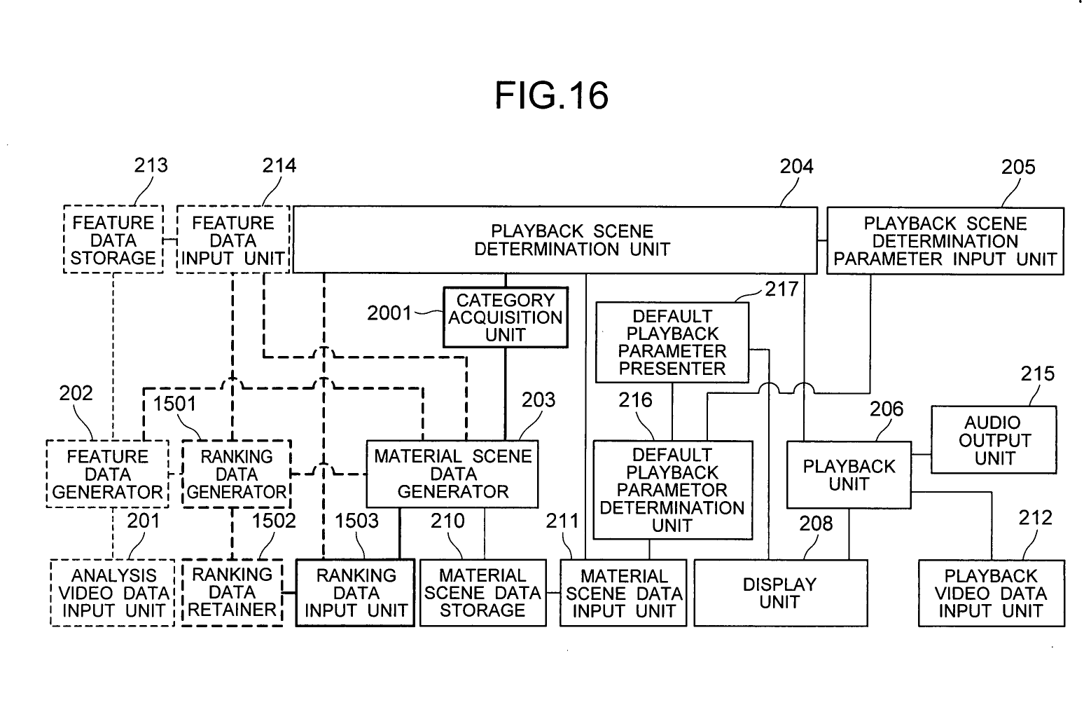

In this case, as shown in FIG. 16, the video processing apparatus is arranged to have a category acquisition unit 2001 in addition to the function blocks of the apparatus indicated in the embodiment 2. The category acquisitor 2001 is designed to acquire the category of video data by means of electronic program guide (EPG) architectures or by input of the video data category from the user via the input device 102. The highlight scene data generator 203 is arranged to generate highlight scene data by a predetermined method which is one of the method shown in the embodiment 1 and the method of embodiment 2 in accordance with the category acquired.

Regarding the playback scene determination unit 204 also, this is designed to determine a sequence of playback scenes by a predetermined method which is either one of the methods shown in the embodiments 1 and 2 in accordance with the video data category obtained by the category acquisitor 2001. Thus it becomes possible to effectively perform reproduction of highlight scenes in a way pursuant to the category of the video data.

This invention should not exclusively be limited the above-stated embodiments and may be implemented while being modified without departing from the scope of the invention. Also note that the embodiments involve various inventive contributions, and various inventive features are extractable by any adequate combinations of a plurality of constituent components disclosed herein. For example, even when one or several components are omitted from such components shown in the embodiments, the intended objective as set forth in the description is attainable. It would readily occur to those skilled in the art that in cases where the effects and advantages stated supra are obtained, such configuration with the components eliminated should be interpreted to fall within the scope of coverage of the invention.

It should be further understood by those skilled in the art that although the foregoing description has been made on embodiments of the invention, the invention is not limited thereto and various changes and modifications may be made without departing from the spirit of the invention and the scope of the appended claims.

1. A video processing apparatus comprising:
video data input means for inputting video data;
highlight scene data input/generation means for inputting or generating highlight scene data with a description of a highlight scene in the video data;
default playback parameter determination means for determining a default playback parameter based on the highlight scene data inputted or generated by the highlight scene data input/generation means;
playback scene determination parameter input means for input of a parameter for determination of a playback scene; and
a control unit for providing control to preferentially use, when a playback parameter is input by the playback scene determination parameter input means, the playback parameter as input by the playback scene determination parameter input means rather than the playback parameter determined by said default playback parameter determination means to reproduce the playback scene of the video data.

2. The apparatus according to claim 1, further comprising:
default playback parameter presentation means for presenting a user with the playback parameter determined by said default playback parameter determination means.

3. The apparatus according to claim 1, wherein said playback parameter is information indicative of a playback time with respect to said video data.

4. The apparatus according to claim 1, wherein said playback parameter is information indicating a ratio of said video data to an entire playback time.

5. The apparatus according to claim 2, wherein said default playback parameter presentation means presents, as the default playback parameter, the user with at least one of a playback time for said video data and a ratio of the video data to an entire playback time.

6. The apparatus according to claim 1, wherein said playback scene determination parameter input means inputs from said default playback parameter determination means any one of a playback time for the video data and a ratio of said video data to an entire playback time.

7. The apparatus according to claim 1, wherein when the playback parameter is input by said playback scene determination parameter input means, if the parameter as input by said playback scene determination parameter input means is larger in value than the parameter determined by said default playback parameter determination means, then said control unit provides control to perform reproduction of more than one playback scene while extending by a specified quantity any one or both of a front part and a rear part of each highlight scene as described in said highlight scene data.

8. The apparatus according to claim 1, wherein when the playback parameter is input by said playback scene determination parameter input means, if the parameter as input by said playback scene determination parameter input means is smaller in value than the parameter determined by said default playback parameter determination means then said control unit provides control to perform reproduction of more than one playback scene while cutting by a specified quantity any one or both of a front part and a rear part of each highlight scene as described in said highlight scene data.

9. A video processing apparatus comprising:
video input means for inputting video data;
ranking data input/generation means for inputting or generating ranking data with ranking added thereto in accordance with a level of importance in units of respective scenes in the video data;
highlight scene data generation means for generating, based on the ranking data, data with a highlight scene described therein;
default playback parameter determination means for determining a default playback parameter based on the highlight scene data as generated by the highlight scene data generation means;
playback scene determination parameter input means for input of a parameter used to determine a playback scene; and
a control unit which provides control in such a way as to preferentially use, when a playback parameter is input by the playback scene determination parameter input means, the playback parameter as input by the playback scene determination parameter input means rather than the playback parameter determined by said default playback parameter determination means to reproduce the playback scene of the video data.

10. The apparatus according to claim 9, further comprising:
default playback parameter presentation means for presenting a user with the playback parameter determined by said default playback parameter determination means.

11. The apparatus according to claim 9, wherein said playback parameter is information indicative of a playback time with respect to said video data.

12. The apparatus according to claim 9, wherein said playback parameter is information indicating a ratio of said video data to an entire playback time.

13. The apparatus according to claim 10, wherein said default playback parameter presentation means presents, as the default playback parameter, the user with at least one of a playback time for said video data and a ratio of the video data to an entire playback time.

14. The apparatus according to claim 9, wherein said playback scene determination parameter input means inputs from said default playback parameter determination means any one of a playback time for the video data and a ratio of said video data to an entire playback time.

15. The apparatus according to claim 9, wherein when the playback scene determination parameter is input by said playback parameter input means, if the parameter as input by said playback scene determination parameter input means is larger in value than the parameter determined by said default playback parameter determination means, then said control unit provides control to perform reproduction of more than one playback scene while extending by a specified quantity any one or both of a front part and a rear part of each highlight scene as described in said highlight scene data.

16. The apparatus according to claim 9, wherein when the playback parameter is input by said playback scene determination parameter input means, if the parameter as input by said playback scene determination parameter input means is smaller in value than the parameter determined by said default playback parameter determination means then said control unit provides control to perform reproduction of more than one playback scene while cutting by a specified quantity any one or both of a front part and a rear part of each highlight scene as described in said highlight scene data.

17. A video processing apparatus comprising:
video data input unit for inputting video data;
highlight scene data input/generation unit for inputting or generating highlight scene data with a description of an important scene in the video data;
default playback parameter determination unit for using the highlight scene data as input or generated by the highlight scene data input/generation means to determine a first playback parameter for reproduction of the video data;
playback scene determination parameter input unit for input of a second playback parameter for reproduction of the video data; and
a control unit operative to provide control in such a way as to reproduce a playback scene of the video data based on the first playback parameter when the second playback parameter fails to be input by the playback scene determination parameter input unit and reproduce, when the second playback parameter is input by the palyback scene determination parameter input unit, the playback scene of the video data based on the second playback parameter.

18. The apparatus according to claim 17, further comprising:
an output unit operative to output at least one of the first and second playback parameters.

19. The apparatus according to claim 17, further comprising:
a ranking data input/generation unit operative to input or generate ranking data with ranking being added thereto in accordance with an importance level in units of scenes in the video data; and
a ranking highlight scene data generation unit for generating, based on the ranking data, highlight scene data indicative of more than one highlight scene of the video data, wherein
said default playback parameter determination unit determines the first playback parameter based on the highlight scene data as generated by said ranking highlight scene data generation unit.

20. The apparatus according to claim 19, further comprising:
feature data input/generation means for inputting or generating feature data describing therein features of said video data as input by said video data input means; and
category acquisition means for acquiring a category of said video data thus inputted, wherein
said control unit is responsive to the category of the video data gained by the category acquisition means, for switching between generation of highlight scene data based on said ranking data and generation of highlight scene data after having determined a highlight scene of the video data based on said feature data.
